(19) United States
(12) Patent Application Publication
(10) Pub. No.: US 2010/0277434 A1
(43) Pub. Date: Nov. 4, 2010

(54) DISPLAY MODULE AND REACTION DEVICE

(75) Inventors: Mu-Tsai Chang, Taipei (TW); Chao-Feng Kang, Taipei (TW); Jhung-Ren Huang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/764,115

(22) Filed: Apr. 21, 2010

(30) Foreign Application Priority Data
Apr. 30, 2009 (TW) 98114413

(51) Int. Cl. G06F 3/041; G06F 3/045; G06F 3/042; G06F 3/043

(52) U.S. Cl. 345/174; 345/173; 345/175; 345/177

(57) ABSTRACT

A display module includes a display panel and a reaction device. The reaction device includes a feedback unit array and a control unit. The feedback unit array has multiple feedback units to be arranged on the display panel in an array to divide the display area into multiple sub display areas, and each sub display area corresponds to one of the feedback units, respectively. When one of the sub display areas is touched, the control unit outputs a control signal to the feedback unit array, and the feedback unit corresponding to the touched sub display area generate a microcurrent.

### CROSS-REFERENCE TO RELATED APPLICATION

This application claims the priority benefit of Taiwan application serial no. 98114413, filed on Apr. 30, 2009. The entirety of the above-mentioned patent application is hereby incorporated by reference herein and made a part of specification.

### BACKGROUND OF THE INVENTION

1. Field of the Invention

The invention relates to a display module and, more particularly, to a display module having a feedback function.

2. Description of the Related Art

With the fast development and application of the information technique, wireless portable communication and information household appliances, to achieve high portability, small size, low weight and human-based operation, many information products use a touch panel instead of a conventional keyboard or mouse as an input device. The touch control technique nowadays is developed mutually, and it is widely used in a mobile phone, a computer, a screen, a touch panel and so on. Due to the convenience and the intuitive operation, the touch control technique becomes the main stream in the market.

The touch panels in the market may be divided into resistance touch panels, capacitance touch panels, infrared touch panels and ultrasonic wave touch panels. The four types of touch panels have different advantages and disadvantages, but they all have no force feedback device. Thus, a user cannot determine whether he or she has inputted information correctly via the tactile sense. For example, when the user strikes the conventional keyboard, a force feedback is generated, and the user may determine that he or she actually stroke the keyboard. However, to a touch panel or a touch screen, the user only may determine whether he or she presses or touches the panel or the screen correctly according to the change of the image on the screen.

### BRIEF SUMMARY OF THE INVENTION

The invention discloses a display module having a reaction device which may allow a user to determine whether he or she inputs information correctly via a tactile sense.

The invention discloses a reaction device adapted to a display panel which may allow a user to determine whether he or she inputs information correctly via a tactile sense.

The invention discloses a display module including a display panel and a reaction device. The reaction device includes a feedback unit array and a control unit. The feedback unit array has multiple feedback units to be arranged on the display panel in an array to divide the display area into multiple sub display areas. In addition, each of the sub display areas corresponds to one of the feedback units, respectively. When one of the sub display areas is touched, the control unit outputs a control signal to the feedback unit array, and the feedback unit corresponding to the touched sub display area generate a microcurrent.

The invention discloses a reaction device adapted to a display panel. The reaction device includes a feedback unit array and a control unit. The feedback unit array has multiple feedback units to be arranged on the display panel in an array to divide the display area on the display panel into multiple sub display areas. Each of the sub display areas corresponds to one of the feedback units. When one of the sub display areas is touched, the control unit outputs a control signal to the feedback unit array, and the feedback unit corresponding to the touched sub display area generate a microcurrent.

In an embodiment of the invention, the reaction device further includes a touch module coupled to the control unit for the control unit to determine whether each sub-display unit is touched according to the output of the touch module.

In an embodiment of the invention, the touch module includes a touch sensing unit array with multiple touch sensing units disposed on the display panel in an array, and each touch sensing unit is coupled to the control unit for the control unit to determine whether each sub display area is touched according to the state of each touch sensing unit.

In an embodiment of the invention, the touch module includes a signal transmitter and a signal receiver. The signal transmitter is disposed on the display panel to transmit physical wave to the display panel. The signal receiver is coupled to the control unit to receive the physical wave transmitted from the signal transmitter to output the sensing signal to the control unit, and the control unit determines whether each sub display area is touched according to the change of the sensing signal.

In an embodiment of the invention, the display panel further includes a touch sensing unit array with multiple touch sensing units coupled to the control unit, and the control unit determines whether each sub display area is touched according to the state of each touch sensing unit.

In an embodiment of the invention, the feedback unit includes an electrode and a transistor. The electrode is disposed on the display panel. The gate of the transistor is coupled to the control unit, the source is coupled to the first voltage, and the drain is coupled to the electrode.

In an embodiment of the invention, the feedback unit includes an electrode, a resistor, a switching unit and a capacitor. The first terminal of the resistor is coupled to the first voltage. The switching unit has a first terminal, a second terminal, a third terminal and a fourth terminal. The first terminal is coupled to the second terminal of the resistor, and the second terminal is coupled to the electrode. The third terminal is coupled to the control unit, receives the control signal outputted by the control unit and makes the fourth terminal conduct with the first terminal or the second terminal. In addition, the first terminal of the capacitor is coupled to the fourth terminal of the switching unit, and the second terminal is coupled to the earth to store and release charge.

Therefore, in the invention, a reaction device in a display module is used to generate the microcurrent to stimulate the user's finger to make the user feel vibration when the user touches the display panel. Thus, the user may determine whether information is input correctly via the tactile sense.

These and other features, aspects and advantages of the present invention will become better understood with regard to the following description, appended claims, and accompanying drawings.

### BRIEF DESCRIPTION OF THE DRAWINGS

FIG. 1 is a block diagram showing the display module in the first embodiment of the invention.

FIG. 2 is a block diagram showing the display module in the second embodiment of the invention.

FIG. 3 is a block diagram showing the display panel in the third embodiment of the invention.

FIG. 4 is a circuit diagram showing the feedback unit in the first embodiment of the invention.

FIG. 5 is a circuit diagram showing the feedback unit in the second embodiment of the invention.

### DETAILED DESCRIPTION OF THE EMBODIMENTS

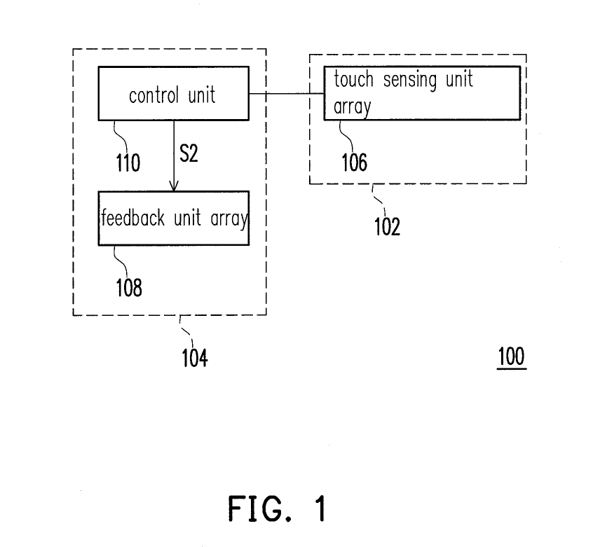

FIG. 1 is a block diagram showing the display module in the first embodiment of the invention. As shown in FIG. 1, the display module 100 includes a display panel 102 and a reaction device 104. The display panel 102 is coupled to the reaction device 104. The display panel 102 may include a touch sensing unit array 106, and the reaction device 104 includes a feedback unit array 108 and a control unit 110. The control unit 110 is coupled to the feedback unit array 108 and the touch sensing unit array 106. The display panel 102 has a display area. The feedback unit array 108 has multiple feedback units, and the feedback units are arranged on the display panel 102 in an array. The display area of the display panel 102 may be divided into multiple sub display areas according to the array arranging mode of the feedback units. That is, each sub display area corresponds to one of the feedback units, respectively. The touch sensing unit array 106 may be embedded in the display panel 102. The position of each touch sensing unit may correspond to one of the sub display areas. The touch sensing unit may be a resistance touch sensing unit or a capacitance touch sensing unit.

The control unit 110 may determine whether the sub display areas are touched. When one of the sub display areas is touched, the control unit 110 outputs a control signal S2 to the feedback unit array 108, and the feedback unit corresponding to the touched sub display area generate a microcurrent.

Detailedly, when the user touches the display panel 102 with an input tool (such as a finger), the electrical characteristic of the touch sensing unit in the touch sensing unit array 106 is changed. The control unit 110 may output the control signal S2 to the feedback unit corresponding to the touched sub display area according to the change of the electrical characteristic of the touch sensing unit. For example, if the touch display panel 102 is a resistance touch panel, when the touch panel is touched, the electrode on the upper layer contacts the electrode on the lower layer of the touch panel to form a short circuit, and thus the voltage drop is generated. The control unit 110 detects the coordinate position of the contact point according to the voltage change. If the touch display panel 102 is a capacitance touch panel, when the touch panel is touched, electrostatic bonding between the transparent electrode of the touch panel and the human body may change the capacitance, and the capacitance change may generate a current. The control unit 110 detects the coordinate position of the touched point according to the generated current. The feedback unit receives the control signal S2 and generates the microcurrent to stimulate the user's finger to make the user's finger feel the vibration.

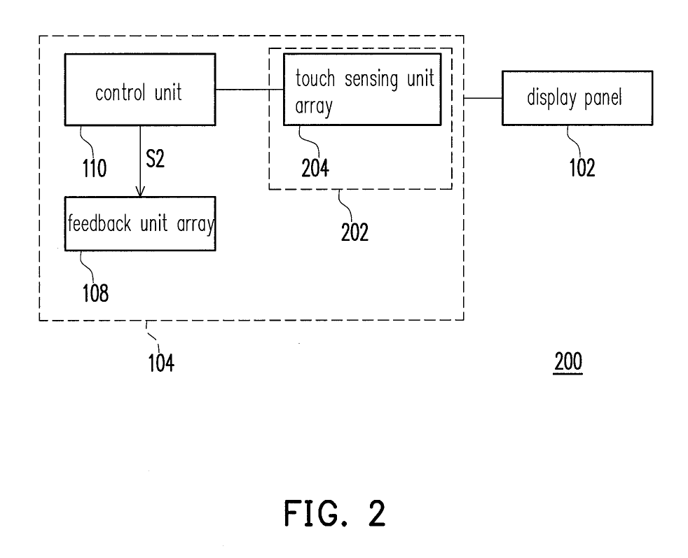

FIG. 2 is a block diagram showing the display module in the second embodiment of the invention. As shown in FIG. 2, the difference between the display module 200 in the embodiment and the display module 100 in FIG. 1 is that the display panel 102 has no built-in touch sensing unit array 106. Therefore, the reaction device 104 disclosed in the embodiment needs an additional touch module 202 coupled to the control unit 110.

In the embodiment, the touch module 202 includes a touch sensing unit array 204. Similarly, the touch sensing unit array 204 includes multiple touch sensing units, and they are disposed on the display panel 102 in an array. Thus, the display panel having no touch control function may have the touch control and feedback function after coupled to the reaction device 104.

When the user touches the display panel 102 with a finger, the control unit 110 may output the control signal S2 to the feedback unit corresponding to the touched sub display area according to the state of the touch sensing unit in the touch sensing unit array 204, and thus to control the feedback unit to generate the microcurrent to stimulate the user's finger to make the user's finger feel the vibration.

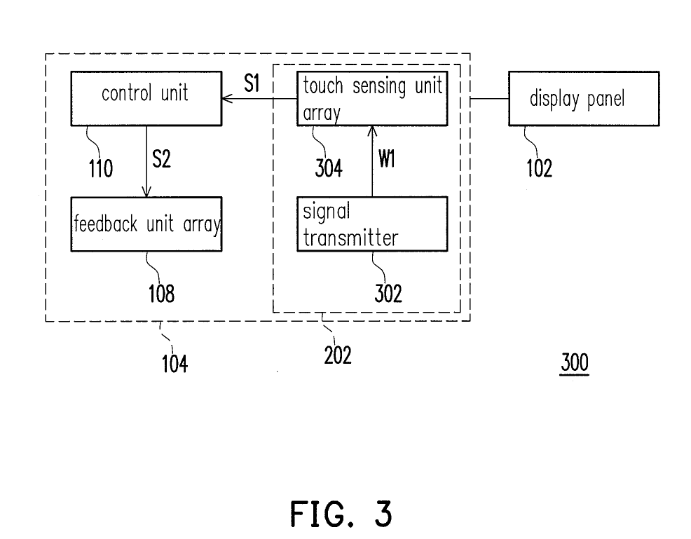

FIG. 3 is a block diagram showing the display panel in the third embodiment of the invention. In the embodiment, the touch module 202 includes a signal transmitter 302 and a signal receiver 304. The signal receiver 304 is coupled to the control unit 110.

The signal transmitter 302 is used to transmit the physical wave W1 on the display panel 102. The signal receiver 304 is used to receive the physical wave W1 transmitted from the signal transmitter 302 to output the sensing signal S1 to the control unit 110, and thus to allow the control unit 110 to determine whether each of the sub display areas is touched according to the change of the sensing signal S1. The physical wave W1 transmitted by the signal transmitter 302 may be a light wave or an ultrasonic wave.

For example, the user may use an ultrasonic wave transmitter and an ultrasonic wave receiver to detect the touched position on the display panel 102. The user may set two ultrasonic wave transmitters at two corners at a diagonal line of the display panel 102 and set two ultrasonic wave receivers at the other two corners of the display panel 102. The two ultrasonic wave transmitters at the diagonal line form an even sound wave field on the display area of the display panel 102. When the sound wave meets a finger or soft objects, the sound wave is absorbed. Therefore, the ultrasonic wave receivers may output the sensing signal S1 according to the change of the received sound wave.

In addition, the user also may use the infrared transmitter and the infrared receiver to detect the touched position on the display panel 102. The user may set infrared transmitters and infrared receivers at two corresponding edges of the display panel 102 to form the interlacing infrared sensing web. When an object touches the display panel 102, the light on the display panel 102 is obstructed. Therefore, the infrared receiver may determine the touched position on the display panel 102 according to the position of the obstructed light and output the sensing signal S1.

The control unit 110 may determine the touched position on the display panel 102 according to the sensing signal S1 outputted by the signal receiver 304 and output the control signal S2 to the feedback unit array 108, and thus to control the feedback unit corresponding to the sub display area of the display panel 102 to generate the microcurrent to stimulate the user's finger to make the user's finger feel the vibration.

To make a skilled person in the art know the operation principle of the invention, several embodiments hereinbelow are used to illustrate the circuit architecture of the feedback units in the feedback unit array 108.

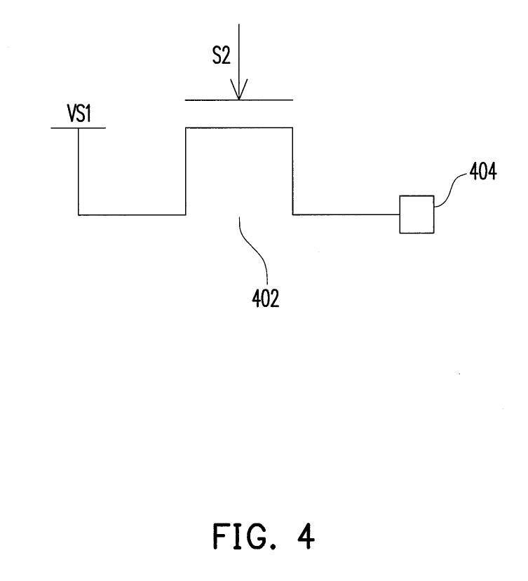

FIG. 4 is a circuit diagram showing the feedback unit in the first embodiment of the invention. As shown in FIG. 4, the feedback unit may include a transistor 402 and an electrode 404. The electrode 404 is disposed on the display panel 102. A gate of the transistor 402 is coupled to the control unit 110, the source is coupled to the first voltage VS1, and the drain is coupled to the electrode 404. The transistor 402 may generate the microcurrent at the electrode 404 according to the control signal S2 outputted by the control unit 110. The transistor 402 may be a thin-film transistor, and the first voltage VS1 is an operating voltage.

Detailedly, when a user's finger touches the display panel 102, the control unit 110 may detect the state of the touch sensing unit in the feedback unit array 108 and output the control signal S2 to the feedback unit corresponding to the touched sub display area. At that moment, the gate of the transistor 402 in the feedback unit may receive the control signal S2 to make the transistor 402 conducted. The first voltage VS1 coupled to the source of the transistor 402 may generate voltage difference between the source and drain of the transistor 402 to generate microcurrent at the electrode 404 to stimulate the user's finger to make the user's finger feel the vibration.

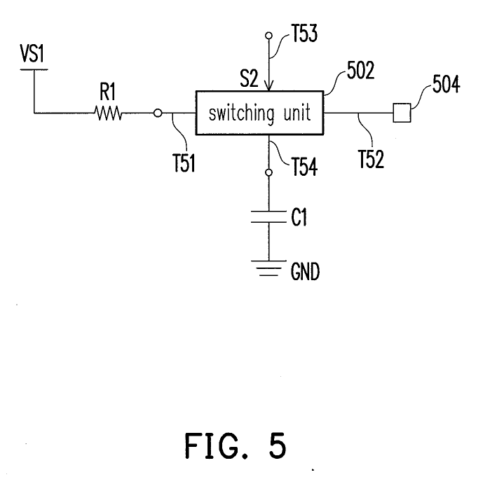

FIG. 5 is a circuit diagram showing the feedback unit in the second embodiment of the invention. As shown in FIG. 5, the feedback unit may include a resistor R1, a capacitor C1, a switching unit 502 and an electrode 504. The first terminal of the resistor R1 is coupled to the first voltage VS1. The first voltage VS1 is an operating voltage. The switching unit 502 has a first terminal T51, a second terminal T52, a third terminal T53 and a fourth terminal T54. The first terminal T51 is coupled to the second terminal of the resistor R1, and the second terminal T52 is coupled to the electrode 504. The third terminal T53 is coupled to the control unit 110, and the fourth terminal T54 is coupled to the first terminal of the capacitor C1. The second terminal of the capacitor C1 is coupled to the ground voltage GND. The third terminal T53 of the switching unit 502 may receive the control signal S2 outputted by the control unit 110 and make the fourth terminal T54 of the switching unit 502 conduct with the first terminal T51 or the second terminal T52. The capacitor C1 is used to store or release the charge.

Detailedly, before the display panel 102 is touched, the fourth terminal T54 of the switching unit 502 is conducted with the first terminal T51. At that moment, the capacitor C1 stores the charge provided by the first voltage VS1. When the user touches the display panel 102 with the finger, the control unit 110 outputs the control signal S2 to the feedback unit corresponding to the touched sub display area according to the state of the touch sensing unit in the feedback unit array 108. The third terminal T53 of the switching unit 502 of the feedback unit may receive the control signal S2 to make the fourth terminal T54 conduct with the second terminal T52 of the switching unit 502. At that moment, the charge stored in the capacitor C1 is released. The moving charge forms the microcurrent to flow to the second terminal T52 of the switching unit 502, and thus to generate the microcurrent on the electrode 504 and further stimulate the user's finger to make the user's finger feel the vibration.

To sum up, the reaction device in the display module in the embodiments may generate the microcurrent when the user touches the display panel. Therefore, the microcurrent stimulates the user's finger to make the user's finger feel the vibration. Therefore, the user may determine whether information is inputted correctly via the tactile sense, and the feedback feeling like the feeling obtained by striking the conventional keyboard is generated.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A display module comprising:
a display panel having a display area;
a reaction device coupled to the display panel and including:
a feedback unit array with multiple feedback units arranged on the display panel in an array to divide the display area into multiple sub display areas, wherein each of the sub display areas corresponds to one of the feedback units; and
a control unit coupled to the feedback unit array, and detecting whether the sub display areas are touched,
when one of the sub display areas is touched, the control unit outputs a control signal to the feedback unit array, and the feedback unit corresponding to the touched sub display area generates a microcurrent.

2. The display module according to claim 1, wherein the reaction device further comprises:
a touch module coupled to the control unit for the control unit to determine whether the sub display areas are touched according to an output of the touch module.

3. The display module according to claim 2, wherein the touch module comprises:
a touch sensing unit array with multiple touch sensing units disposed on the display panel in an array, wherein each of the touch sensing units is coupled to the control unit, and the control unit determines whether each of the sub display areas is touched according to the states of the touch sensing units.

4. The display module according to claim 3, wherein each of the touch sensing units is a resistance touch sensing unit or a capacitance touch sensing unit.

5. The display module according to claim 2, wherein the touch module comprises:
a signal transmitter disposed on the display panel to transmit a physical wave to the display panel; and
a signal receiver coupled to the control unit and receives the physical wave transmitted from the signal transmitter to output a sensing signal to the control unit, and the control unit determines whether the sub display areas are touched according to the change of the sensing signal.

6. The display module according to claim 5, wherein the physical wave is light wave or ultrasonic wave.

7. The display module according to claim 1, wherein the display panel further comprises:
a touch sensing unit array with multiple touch sensing units coupled to the control unit, and the control unit determines whether each of the sub display areas is touched according to the states of the touch sensing units.

8. The display module according to claim 1, wherein each of the feedback units comprises:
an electrode disposed on the display panel; and
a transistor whose gate is coupled to the control unit, source is coupled to a first voltage, and drain is coupled to the electrode.

9. The display module according to claim 8, wherein the first voltage is an operating voltage.

10. The display module according to claim 8, wherein the transistor is a thin-film transistor.

11. The display module according to claim 8, wherein each of the feedback units in the feedback unit array comprises:
an electrode;
a resistor whose first terminal is coupled to the first voltage;
a switching unit having a first terminal, a second terminal, a third terminal and a fourth terminal, wherein the first terminal is coupled to the second terminal of the resistor, the second terminal is coupled to the electrode, the third terminal is coupled to the control unit, receives the control signal outputted by the control unit and makes the fourth terminal conduct with the first terminal or the second terminal; and
a capacitor whose first terminal is coupled to the fourth terminal of the switching unit and whose second terminal is coupled to a ground voltage to store and release charge.

12. A reaction device adapted to a display panel, the reaction device comprising:
a feedback unit array with multiple feedback units arranged on the display panel in an array to divide the display area of the display panel into multiple sub display areas, wherein each of the sub display areas corresponds to one of the feedback units, respectively; and
a control unit coupled to the feedback unit array, and detecting whether the sub display areas are touched,
when one of the sub display areas is touched, the control unit outputs a control signal to the feedback unit array, and the feedback unit corresponding to the touched sub display area generate a microcurrent.

13. The reaction device according to claim 12, wherein the reaction device further comprises:
a touch module coupled to the control unit for the control unit to determine whether the sub display areas are touched according to an output of the touch module.

14. The reaction device according to claim 13, wherein the touch module comprises:
a touch sensing unit array with multiple touch sensing units disposed on the display panel in an array, wherein each of the touch sensing units is coupled to the control unit, and the control unit determines whether each of the sub display areas is touched according to the states of the touch sensing units.

15. The reaction device according to claim 14, wherein each of the touch sensing units is a resistance touch sensing unit or a capacitance touch sensing unit.

16. The reaction device according to claim 13, wherein the touch module comprises:
a signal transmitter disposed on the display panel to transmit a physical wave to the display panel; and
a signal receiver coupled to the control unit and receives the physical wave transmitted from the signal transmitter and outputting a sensing signal to the control unit, and the control unit determines whether the sub display areas are touched according to the change of the sensing signal.

17. The reaction device according to claim 16, wherein the physical wave is a light wave or an ultrasonic wave.

18. The reaction device according to claim 12, wherein each of the feedback units comprises:
an electrode disposed on the display panel; and
a transistor whose gate is coupled to the control unit, source is coupled to a first voltage, and drain is coupled to the electrode.

19. The reaction device according to claim 18, wherein the first voltage is an operating voltage.

20. The reaction device according to claim 18, wherein the transistor is a thin-film transistor.

21. The reaction device according to claim 18, wherein each of the feedback units in the feedback unit array comprises:
an electrode;
a resistor whose first terminal is coupled to the first voltage;
a switching unit having a first terminal, a second terminal, a third terminal and a fourth terminal, wherein the first terminal is coupled to a second terminal of the resistor, the second terminal is coupled to the electrode, the third terminal is coupled to the control unit and receives the control signal outputted by the control unit and make the fourth terminal conduct with the first terminal or the second terminal; and
a capacitor whose first terminal is coupled to the fourth terminal of the switching unit, and whose second terminal is coupled to a ground voltage to store and release charge.
